(19) United States
(12) Patent Application Publication
(10) Pub. No.: US 2002/0143995 A1
(43) Pub. Date: Oct. 3, 2002

(54) Method of sending mobile phone short message via electronic mail and method of transaction by using same

(76) Inventor: Hao-Ming Yeh, Taipei (TW)

Correspondence Address: BROWDY AND NEIMARK, P.L.L.C., 624 NINTH STREET, NW, SUITE 300, WASHINGTON, DC, 20001-5303, US

(21) Appl. No.: 09/880,032

(22) Filed: Jun. 14, 2001

(30) Foreign Application Priority Data
Mar. 29, 2001 (TW) 90107451

(51) Int. Cl. G06F 15/16

(52) U.S. Cl. 709/246; 709/206

(57) ABSTRACT

A method of sending a mobile phone short message via e-mail and a transaction method using same involving a user end which sends e-mail to a conversion mail server via the sender mail server. The e-mail information is converted by the conversion mail server into a short message recipe which is sent to a short message server and then to the receiving end mobile phone. The contents of the e-mail contain a verification stamp information for verifying, managing and cost calculation of the message transmission. The user can send directly the short message in the form of e-mail to the mobile phone user via internet, without the entry of information by means of mobile phone keyboard.

### FIELD OF THE INVENTION

The present invention relates generally to a service method of a mobile phone, and more particularly to a method of sending mobile phone short message via electronic mail and a method of transaction by using same.

### BACKGROUND OF THE INVENTION

As shown in FIG. 1, the prior art method of sending the mobile phone short message involves a sender who uses his own mobile phone to enter the short message content into the mobile phone 16. Thereafter, the message is transmitted by radio to the system service operator of the mobile phone. The message is transmitted by radio to the receiving end mobile phone 67 via the short message computer server 63 and several switches 65. The short message is finally exhibited on the display of the receiving end mobile phone 67.

The prior art method described above is defective in design in that the entry is not conveniently done. The mobile phone has a digital keyboard by which the entry is done. The entry of Chinese and English is very difficult. Many keys must be pressed. The entry is time-consuming. The ordinary user can not put up with such difficulty. As a result, the use of the mobile phone short message is rather limited and is not well received.

In addition, in the field of internet, the use of electronic mail is gaining popularity. As shown in FIG. 2, the conventional method of transmitting the electronic mail involves a sender end 71, which sends out an electronic mail to a mail server device 73 of the sender end. The electronic mail is then sent via the public internet to the mail server device 75 of a receiver end 77, which is then connected with the mail server 5 of the receiver end, so as to receive the electronic mail. This method has advantages. It is fast, capable of sending a large amount of message, the files, and the like.

The conventional method of sending electronic mail has drawbacks, which have not yet been overcome. In other words, it is incapable of realtime delivery. When the receiver is not on site with the computer or when the computer is not booted, there is no way that the receiver can see the contents of the electronic mail. As a result, the sender must often resort to the telephone by which the receiver is informed of the e-mail dispatch. In addition, it is not convenient to carry the computer around. In spite of the ubiquitousness of mobile phone, the mobile phone capable of sending e-mail is rather expensive. The internet communication by WAP is also costly.

### SUMMARY OF THE INVENTION

It is the primary objective of the present invention to provide a method of sending short message of mobile phone via E-mail and a method of conducting transaction by using same. The method involves the use of a personal computer to send the short message to the receiving end mobile phone via the e-mail, thereby simplifying the entry. In light of the software versatility of the e-mail dispatch, the function of batch or time transmission is thus attained.

It is another objective of the present invention to provide a method of sending the simple mobile phone message via E-mail and a transaction method using same. The method overcomes the deficiency of the conventional e-mail dispatch in such a manner that the receiving end mobile phone is informed of the e-mail dispatch via the mobile phone system operator. The method of the present invention gives an added value to the e-mail.

It is still another objective of the present invention to provide a method of sending a simple mobile phone message via E-mail and a transaction method using same. The method is capable of verifying, managing and charging each transmission at the time when the e-mail dispatch takes place.

### BRIEF DESCRIPTION OF THE DRAWINGS

FIG. 1 shows a schematic diagram of the conventional method of dispatching a mobile phone short message.

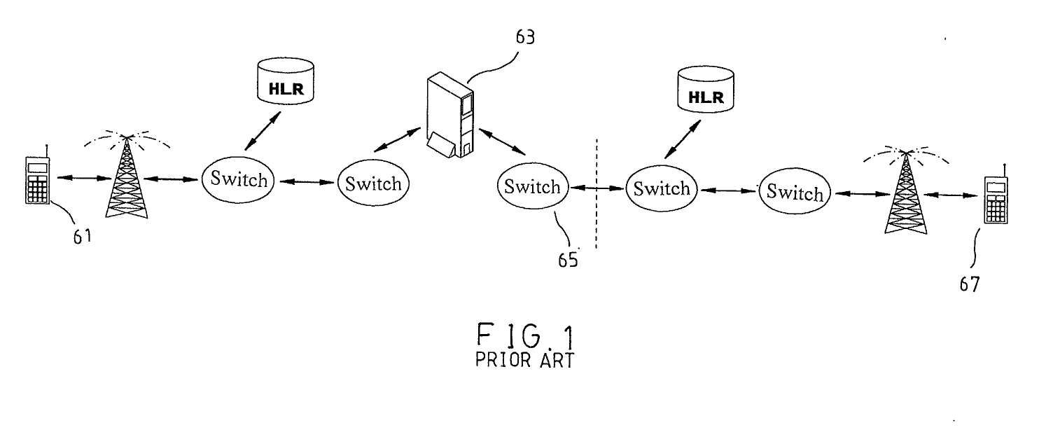

FIG. 2 shows a schematic flow process of the conventional method of dispatching the e-mail.

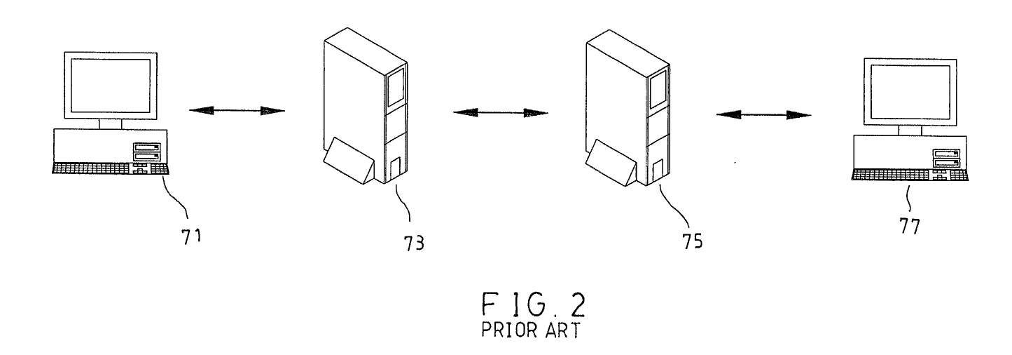

FIG. 3 shows a schematic flow process of a preferred embodiment of the present invention.

FIG. 4 shows an exemplification table of stamp information verification using the transaction method of the present invention.

### DETAILED DESCRIPTION OF THE INVENTION

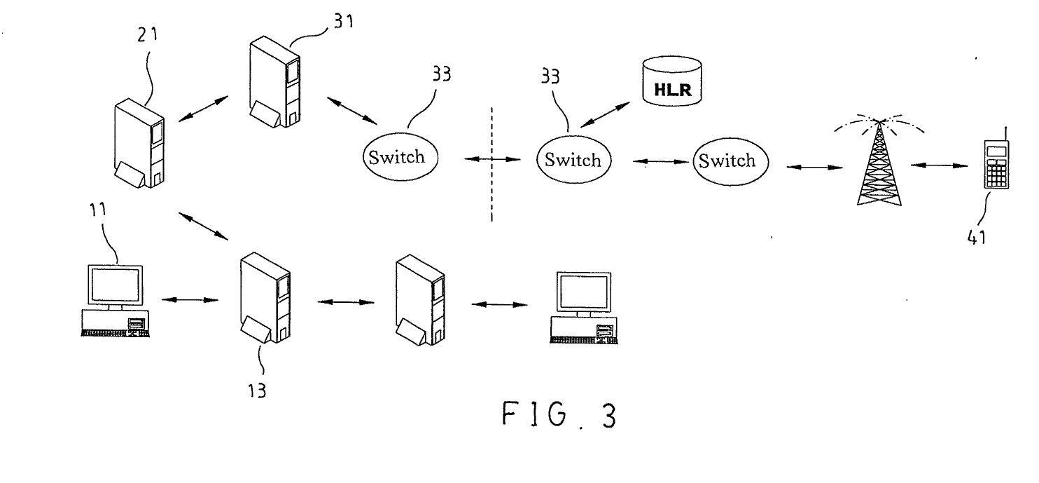

As shown in FIG. 3, a user end 11 sends the electronic mail via a sender mail server 13 to a EMX mail server 21, from which the data of the e-mail are converted to a short message recipe, which is sent to a short message server 31. The converted short message is then sent from the short message server 31 to the designated receiving end mobile phone 41.

The user end 11 of the present invention is a computer system which is provided with an e-mail program of Outlook of Microsoft capable of dispatching e-mail and allowing the user to enter the e-mail contents. The e-mail is dispatched by the sender mail server 13 to EMX mail server 21 via internet. The sender mail server 13 is provided by ISP (Internet Service Provider).

The EMX server 21 retrieves the telephone number from the remark column of the e-mail after it has received the e-mail from the sender mail server 13. If necessary, the mail address and the subject of the mail are retrieved. The e-mail contents are packaged in the recipe that is acceptable to the short message system of the mobile phone operator, and then to the short message server 31.

The data of the e-mail must contain at least the phone number of the receiving end mobile phone 41. The phone number is recorded in the receiver column, C.C. column or B.C.C. column of the e-mail protocol remark columns. Once the e-mail is sent by the user, the receiver will acknowledge the e-mail contents via his mobil phone only in such a manner that the phone number is recorded in the receiver column. On the other hand, the receiver will acknowledge the e-mail contents by his e-mail receiving program and mobil phone in such a manner that the phone is recorded in the C.C. column or B.C.C. column. In other word, the present invention will create a wonderful effect that the receiver will get a real-time message/note from his mobil phone as soon as the user of present invention sends a e-mail to him. The remark column may also contain other data, such as the data of the sender and the receiver whom the system operator wants to manage, as well as identification verification, payment verification, etc. An example is shown as follows:

0921999999#oeyKBcmjEMN5693<emx@1390.com.tw> (1)

“0921999999” of the form (1) is the phone number of the receiving end. The letter series of “#oeyKBcmjEMN5693” stand for indentification verification. “emx@1390.com.tw” stands for a mail box of the conversion mail server.

The short message server 31 is SMS short message center server established by the mobile phone operator. After receiving the data in the acceptable recipe from EMX mail server 21, the short message server 31 transmits by radio wave the data to the mobile phone 41 of the receiving end via the switch 33 of the mobile phone operator. The input is thus done with ease and speed. In the application of the present invention, the message contents are entered in the computer to the columns of subject and content of the e-mail as well as the receiving end phone number and the related verification data in the remark column. The receiver address is designated as EMX designated mail account address, such as emx @1390.com.tw of the form (1). The data are sent to the mail server 13 by means of which the designated mail account address is sent to the EMX mail server 21 which verifies and records the data before converting the data recipe into the short message recipe which is sent to the short message server 31 from which the message is sent by radio to the receiving end mobile phone 41. The process described above is identical with the e-mail dispatch. It is only necessary to enter the receiving end mobile phone number in the remark column, without the replacement of the user end mail dispatch software. As a result, there is no problem of compatibility.

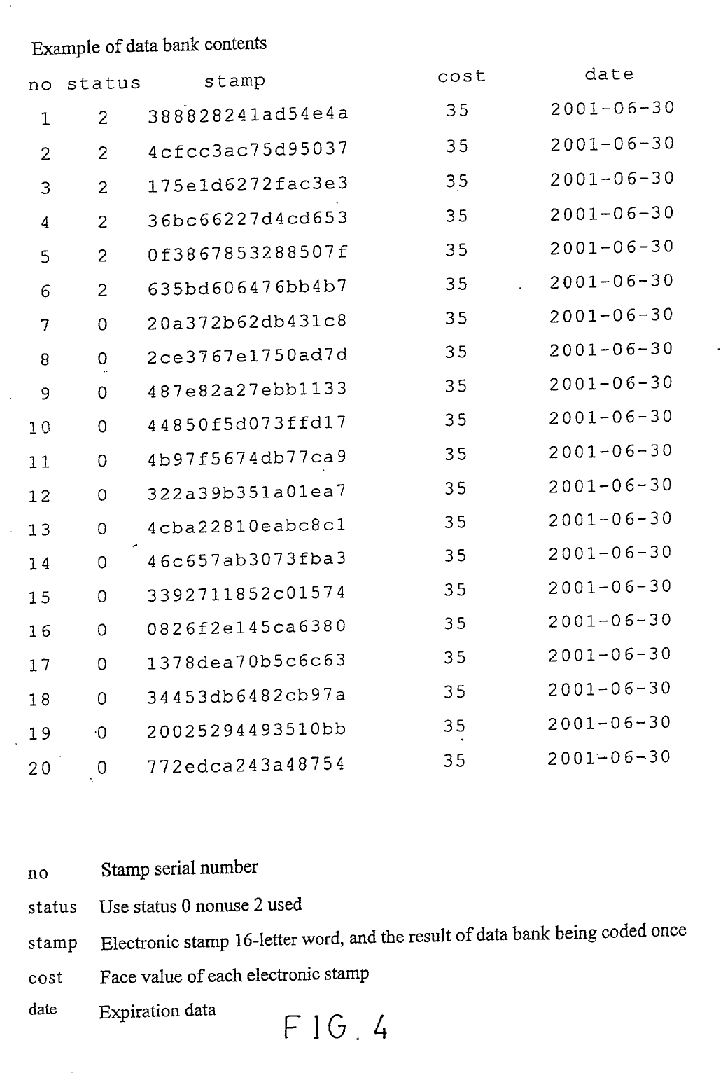

The short message transmission is different in cost from the e-mail. The use of the method described above will incur expenses. The present invention can not be used widely without a secure transaction method. As a result, the use of the transaction method described above calls for a charge and management mechanism that is established on the operation of transmission of short message to mobile phone in the form of e-mail and must consist of a stamp verifying information which is a specified letter series recorded in the remark column. As shown in FIG. 4, the letter series contain serial number, use status, confidential code, face value and term of validity. The status 2 stands for “has been used”. The status 0 stands for “not yet used”. The stamp is a combination of letters, symbols or numbers. The stamp has a total 16 characters. The cost is 35 cents. The term of validity is 2001-06-30.

The verification stamp data can be judged by the EMX mail server 21 if they have been used, sold or invalidated in the verification process. If used, it is marked by the EMX mail server 21 after the e-mail transmission, so as to prevent the second transmission. If it is in the usable status, the transmission is allowed. On the other hand, this record can be considered a transaction record to be examined later. By using the method described above, verification, management and cost calculation of the e-mail transmission are done.

The e-mail management program of the present invention is not limited to the Outlook e-mail program, the Netscape program, or the Eudora program. Accordingly, the EMX mail server of the present invention may be Sendmail or MS-Exchange server.

The present invention has several advantages. In the first place, the present invention enables the short message to be sent conveniently to the receiving end mobile phone 41 by means of e-mail via the internet. There is no need to do the input on the mobile phone. In addition, the receiver of the e-mail can not only received the e-mail in his desktop computer but also promptly notified by the short message in his mobile phone, thanks to the present invention. Through the use of the present invention, the transmission of the short message can be managed in such a manner that each transmission is charged, and that the batch or time transmission is attained. By means of such a charge mechanism, the high quality service of transmission of short message is made possible.

What is claimed is:

1. A method of sending a mobile phone short message via electronic mail, said method involving a user end which sends via a mail server an electronic mail to a conversion mail server by which the e-mail data are converted to a short message recipe that is sent to a short message server from which the message is sent to a receiving end mobile phone; wherein said user end has a function of sending e-mail, entering the contents of the e-mail, and dispatching the e-mail to the sender mail server via internet;
wherein said e-mail at least contains the receiving end mobile phone number;
wherein said sender mail server is for use in receiving the e-mail from the user end and dispatching the e-mail to said conversion mail server;
wherein said conversion mail server retrieves at least one information of the e-mail upon having received the e-mail from said sender mail server, the information being converted into a short message recipe which is transmitted to said short message server;
wherein said short message server sends the e-mail to the receiving end mobile phone by radio wave upon having received the information in the short message recipe;
by means of the above steps, the user being capable of sending e-mail via internet to the mobile phone user, without the use of keyboard of the mobile phone.

2. The method as defined in claim 1, wherein said user end is a computer system.

3. The method as defined in claim 2, wherein said computer system is provided with an e-mail processing program.

4. The method as defined in claim 3, wherein said e-mail processing program is Microsoft's Outlook program.

5. The method as defined in claim 1, wherein the phone number of said e-mail is disposed in a remark column of said e-mail.

6. The method as defined in claim 1, wherein said e-mail further contains indentification verifying information.

7. The method as defined in claim 6, wherein said indentification verifying information is recorded in the remark column of the e-mail.

8. The method as defined in claim 1, wherein said e-mail is sent via said sender mail server to a mail box which is set up in said conversion mail server.

9. The method as defined in claim 1, wherein said conversion mail server is an EMX mail server.

10. The method as defined in claim 9, wherein said conversion mail server retrieves information from said e-mail and packages the information in a recipe acceptable to a short message system of the mobile phone operator.

11. The method as defined in claim 1, wherein said conversion mail server retrieves at least the receiving end phone number of the e-mail.

12. The method as defined in claim 1, wherein said short message server is an SMS short message center server of the mobile phone operator.

13. The method as defined in claim 1, wherein the retrievable data of said e-mail include the sender address, mail subject, mail contents, and receiving end mobile phone number.

14. A cost transaction method using the method of sending the mobile phone short message by e-mail, said transaction method involving a user end which sends e-mail via the sender mail server to a conversion mail server which converts the e-mail information into a short message recipe that is sent to a short message server from which the message is sent to a designated receiving end mobile phone;
wherein said user end has a softward capable of sending e-mail, allowing user to enter the e-mail contents, and sending e-mail to said sender mail server via internet;
wherein said e-mail contains at least the receiving end phone number;
wherein said sender mail server receives from said user end the e-mail which is then sent to said conversion mail server;
wherein said switch mail server retrieves at least one information from said e-mail upon having received the e-mail from said sender mail server, the information being converted by said conversion mail server into a short message recipe which is then sent to said short message server;
wherein said short message server transmits by radio wave the information in the short message recipe to the designated receiving end mobile phone number;
wherein said e-mail further contains a verification stamp information, which must be contained in the e-mail at the time when the user end mails the e-mail to said mail server in which the verification stamp information is compared with the data base in such a manner that the e-mail is returned to the sender in case of lack of agreement between the verification stamp information is compared with the data base in such a manner that the e-mail is returned to the sender in case of lack of agreement between the verification stamp information and the data base;
the method requiring a user to purchase said verification stamp information such that the e-mail message is converted into the short message which is then sent to the receiving end mobile phone.

15. The cost transaction method as defined in claim 14, wherein said verification stamp information is a specific combination of series of words.

16. The cost transaction method as defined in claim 14, wherein said verification stamp information is disposed in a remark column of the e-mail.

17. The cost transaction method as defined in claim 14, wherein said verification stamp information contains serial number, use status, term of validity, code, face value, etc.

18. The cost transaction method as defined in claim 17, wherein said verification stamp information is marked “used” in the use status of the data base corresponding to the verification stamp information such that the used verification stamp information is invalidated.
